(19) United States
(12) Patent Application Publication
(10) Pub. No.: US 2024/0242156 A1
(43) Pub. Date: Jul. 18, 2024

(54) SYSTEMS AND METHODS FOR HANDLING SUSTAINABILITY LEVEL IN PHYSICAL INFRASTRUCTURE

(71) Applicant: SMARTER DHARMA SUSTAINABLE SOLUTIONS, Bengaluru Urban, Bengaluru (IN)

(72) Inventors: Sriram KUCHIMANCHI, Vidyaranyapura (IN); Hongxin YANG, Vidyaranyapura (IN)

(73) Assignee: SMARTER DHARMA SUSTAINABLE SOLUTIONS, Bengaluru Urban, Bengaluru (IN)

(21) Appl. No.: 18/289,844

(22) PCT Filed: May 6, 2022
(86) PCT No.: PCT/IN2022/050448

§ 371 Date: Nov. 7, 2023

(30) Foreign Application Priority Data
May 7, 2021 (IN) 202141020793

(51) Int. Cl. G06Q 10/0637

(52) U.S. Cl. CPC G06Q 10/06375

(57) ABSTRACT

Embodiments herein provide methods and systems for handling a level of a sustainability in a physical infrastructure by an electronic device (100). The method includes receiving the parameter corresponding to the sustainability in the physical infrastructure. The parameter includes goals and status at the instant of usage, an interventions selected (solutions chosen by the user), an impact achieved based on each solution, local environmental challenges, and the definition of each of the individual levels and what they mean. Further, the method includes determining the level of a sustainability in the physical infrastructure based on the received parameter.

### CROSS REFERENCE TO RELATED APPLICATION

This application is based on and derives the benefit of Indian Provisional Application 202141020793, the contents of which are incorporated herein by reference.

### TECHNICAL FIELD

Embodiments disclosed herein relate to sustainability level management systems, and more particularly related to methods and systems for handling a sustainability level in a physical infrastructure.

### BACKGROUND

There are few ranking systems (e.g., Leadership in Energy and Environmental Design (LEED), Indian Green Building Council (IGBC), Green Rating for Integrated Habitat Assessment (GRIHA), etc.,) for handling a sustainability level for a physical infrastructure based on a manual approach. The manual approach is performed mostly by using a software tool (e.g., EXCEL, or the like), so that the manual approach provides static results. Further, most manual approaches do not consider comprehensively a local ecology impact with respect to resource depletion. Further, the current ranking systems are primarily focused on a design and completion of the project (e.g., building construction, real estate or the like) and a performance of the project isn't part of the ranking system. Further, the LEED has a certification which has performance as part of it. However, the LEED don't have a dynamic approach to measure instantly and keep rating (levels) active. Further, the considering the performance of the project requires an additional activity and isn't easy, so that the ranking systems are not followed up by a real estate developer.

### OBJECTS

The principal object of the embodiments herein is to disclose methods and systems for handling a sustainability level for a physical infrastructure.

### SUMMARY

Accordingly, the embodiments herein provide methods and systems for handling a level of a sustainability for a physical infrastructure. The method includes receiving one or more parameter corresponding to the sustainability of the physical infrastructure. The parameter includes goals and status at the instant of usage, various interventions selected (solutions chosen by the user), impact achieved based on each solution, local environmental challenges, and the definition of each of the individual levels and what they mean. Further, the method includes determining the level of the sustainability in the physical infrastructure based on the received parameter.

In an embodiment, determining, by the electronic device, the level of the sustainability in the physical infrastructure based on the at least one received parameter includes estimating, by the electronic device, a sustainability score based on the at least one received parameter, wherein the sustainability score is determined based on a sustainability score contribution of intervention on dimension and an optimal decision value for intervention that impacts dimension; and determining, by the electronic device, the level of the sustainability in the physical infrastructure based on the estimated sustainability score.

In an embodiment, the method includes monitoring, by the electronic device, at least one received parameter corresponding to the sustainability level in the physical infrastructure over a period of time. Further, the method includes estimating, by the electronic device, a feedback corresponding to the at least one received parameter. Further, the method includes determining, by the electronic device, the level of the sustainability in the physical infrastructure based on the estimated feedback.

In an embodiment, the at least one parameter comprises goals and status at an instant of usage, an interventions solutions selected by a user of the electronic device, an impact achieved based on each solution, local environmental challenges, and a definition of each of individual levels.

In an embodiment, the effect of the intervention is deterministic or stochastic over time.

Accordingly, the embodiments herein provide an electronic device for handling sustainability goal setting for a physical infrastructure. The electronic device includes a sustainability goal setting controller coupled with a processor and a memory. The sustainability goal setting controller is configured to receive at least one parameter corresponding to the sustainability level in the physical infrastructure and determine the level of the sustainability in the physical infrastructure based on the at least one received parameter.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The embodiments disclosed herein are illustrated in the accompanying drawings, throughout which like reference letters indicate corresponding parts in the various figures. The embodiments herein will be better understood from the following description with reference to the drawings, in which:

FIG. 1 shows various hardware components of an electronic device for handling a level of sustainability for a physical infrastructure, according to embodiments as disclosed herein;

FIG. 2 is a flow chart illustrating a method for handling the level of the sustainability in the physical infrastructure, according to embodiments as disclosed herein; and

FIG. 3 is an example illustration in which a user interface shows the level of the sustainability in the physical infrastructure, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods and systems for handling sustainability level of a physical infrastructure. The method includes receiving one or more parameter corresponding to the sustainability of the physical infrastructure. The one or more parameter includes goals and status at the instant of usage, an interventions selected (solutions chosen by the user), an impact achieved based on each solution, local environmental challenges, and the definition of each of the individual levels and what they mean. Further, the method includes determining the level of a sustainability in the physical infrastructure based on the received parameter.

Unlike conventional methods and systems, the proposed method can be used to handle the level of the sustainability of the physical infrastructure in an automatic and dynamic manner. This results in enhancing the user experience. The proposed method can be used to handle the level of the sustainability of the physical infrastructure by considering the local ecology impact with respect to the resource depletion. The proposed method can be used to handle the level of the sustainability of the physical infrastructure in a real time. In the proposed method, financial and sustainability data is harnessed to minimize environmental impact and enhance the reputation of a business. The method can be used to reduce the resource wastage and increase efficiency in the utilization of energy, water and natural resources and materials in a better manner. The method can be used to achieve a green building design and contribute to a low-carbon future. The method can be used to achieve greater positive impact and easier maintenance.

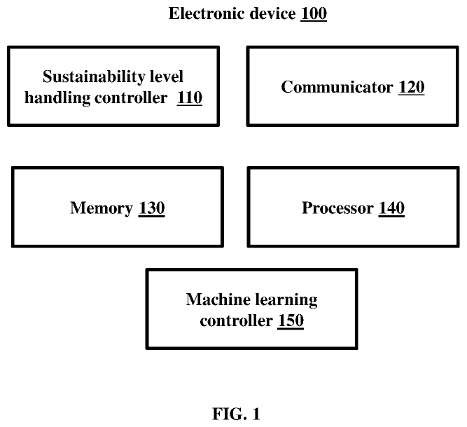

Referring now to the drawings, and more particularly to FIGS. 1 through 3, where similar reference characters denote corresponding features consistently throughout the figures, there are shown at least one embodiment.

FIG. 1 shows various hardware components of an electronic device (100) for handling a level of a sustainability of a physical infrastructure, according to embodiments as disclosed herein. The electronic device (100) can be, for example, but not limited to a smart phone, a smart watch, a Personal Digital Assistant (PDA), a tablet computer, a laptop computer, a virtual reality device, an immersive system, an Internet of Things (IoT), a smart sensor, a drone, a server, a smart vehicle or the like. The server can be, for example, but not limited to a third party server, a cloud server, an edge server or the like. The physical infrastructure can be, for example, but not limited to a construction site, real estate site, a building design, an agriculture land, a park, a hospital, a bus stand, a metro station, an airport or the like. The physical infrastructure can also be an existing building site and existing building operations and maintenance.

In an embodiment, the electronic device (100) includes a sustainability level handling controller (110), a communicator (120), a memory (130), a processor (140) and a machine learning controller (150). The processor (140) is operated with the sustainability level handling controller (110), the communicator (120), the memory (130) and the machine learning controller (150). The sustainability level handling controller (110) can be act as a sustainable resource platform.

The sustainability level handling controller (110) is configured to receive a parameter corresponding to the sustainability level in the physical infrastructure. The parameter includes goals and status at the instant of usage, an interventions selected (solutions chosen by the user), an impact achieved based on each solution, local environmental challenges, and the definition of each of the individual levels and what they mean. In an example, the goal is amount of energy generated from renewable sources. Example for interventions selected would be something like solar water heating in line with energy goal. The impact achieved would be number of units of power generated from the solar, as opposed to grid or diesel generator, etc., to heat the water. Example for the Local environmental challenges would be for a specific geography if ground water is scarce, then that's a local challenge which should be considered. So, if the location of the project has water issue, but the focus on water is less than focus on energy, then the proposed method is impacted as the priorities are wrong.

Based on the received parameter, the sustainability level handling controller (110) is configured to determine the sustainability level in the physical infrastructure. In an example, the user interface (300) shows the level of the sustainability in the physical infrastructure in the FIG. 3.

Below is an example for determining the level of the sustainability in the physical infrastructure.
a) Level-1: Basic sustainability level.
   (1) Meeting local government policy mandate of resource consumption and design requirements like energy, water consumption and waste management.
   (2) An X % increment on the goals set (beyond the basic government mandate, where X is a predefine level and set by the user of the electronic device (100).
   (3) The basic sustainability level meets at least one intervention per section (sections being energy, water, waste and carbon).
b) Level-2.
   (1) Everything from ‘Level1’.
   (2) An (X+15) % increment on the goals set.
   (3) Level-2 meets at least 3 intervention in at least 1 section (sections being energy, water, waste and carbon).
c) Level-3.
   (1) Everything from ‘level 2’.
   (2) An (X+30) % increment on the goals set.
   (3) Level-3 meets at least 3 intervention in a minimum of 2 sections (sections being energy, water, waste and carbon).
   (4) Local resource challenge addressed better. In an example, if the project is in Devanahalli, Bangalore. Water is an issue in the Devanahalli, Bangalore. So, the project should have approved more water related interventions rather than others (need to figure out how many).
d) Level-4.
   (1) Everything from ‘level 3’
   (2) An (X+50) % increment on the goals set.
   (3) All interventions recommended in a minimum of 2 sections (sections being energy, water, waste and carbon).
   (4) Local resource challenge addressed better. For instance, if the project is in the Devanahalli, Bangalore. Water is an issue in the Devanahalli, Bangalore, so that, the project should have approved more water related interventions rather than others (need to figure out how many—which needs to be more than level 3).

In an example, the proposed method also describes optimal construction decision recommendation for maximizing building construction and ongoing expenses of a building such as an apartment, home or commercial building. The sustainability of a building is measured in n dimensions where the dimensions could refer to energy consumption, water consumption or waste processing. The cumulative sustainability rating of the building—which we call it as sustainability score (i.e., DharmaScore) is an aggregation of scores across n dimensions. In each of n dimension, one could take m decisions to affect the score. The user of the electronic device (100) calls these interventions. For example, an energy score can be affected by interventions such as lighting or Heating, ventilation, and air conditioning (HVAC) decisions. Depending on the country or region of building site, minimum levels of specific interventions could be mandated by government. Example of such a mandate can be minimum rain water harvesting levels. Based on the geography, weather conditions and local sustainability needs, each of these interventions may have a potential maximum. An example of that is maximum solar panel intervention based on roof size and expected sunlight amount. Furthermore, the interventions can have effect on multiple dimensions. For example, waste water bio gas intervention affects the energy, water and waste dimensions each with different magnitude. In addition, the effect of specific intervention on one or more dimensions can be nonlinear including multivariate in the case of interrelated interventions, step function with some segments linear or exponential or other function. Furthermore, the effect of interventions can be time dependent meaning that effect can be increasing or decreasing or stochastic over time based on other conditions. Given the sustainability Score is influenced by interrelated interventions and the aggregated score across all dimensions, without an optimization model, the intervention decisions will be myopic and therefore will not be optimal. The proposed method formulates this problem using optimization methodology to recommend optimal interventions that maximizes the sustainability Score given the interventions, their deterministic and stochastic effect on sustainability Score while adhering to mandates and not exceeding maximum potential as shown in the below equations.
n=number of dimensions;
mᵢ=number of interventions in dimension i
s_{i,j}=sustainability score contribution of intervention j on dimension i
Md_{i,j}=Mandated minimum requirement of intervention j that impacts dimension i
Mx_{i,j}=Maximum potential deployable for intervention j that impacts dimension i
DS=sustainability Score (i.e., DharmaScore)
D_{i,j}=Optimal decision value for intervention j that impacts dimension i
Pₓ(i, j)=Piecewise multiplier for intervention j that impacts dimension i
Cₓ(i,j)=Piecewise constant for intervention j that impacts dimension i
aₖ, bₖ=Piecewise segment limits

$$Maximize DS = f ( {S}_{i , j} , {D}_{i , j} ) \qquad ( 1 )$$

$$Subject to : {Md}_{i , j} \leq {D}_{i , j} \leq {Mx}_{i , j} ∀ i , j \qquad ( 2 )$$

$$Where DS can be of one or a combination of the following forms :$$

$$DS = {\sum }_{i , j} {S}_{i , j} {D}_{i , j} \qquad ( 3 )$$

$$DS = {\sum }_{i , j , k} {P}_{k} ( i , j ) {S}_{i , j} {D}_{i , j} + {C}_{k} ( i , j ) if i \leq {a}_{k} , j \leq {b}_{k} {∀}_{k} \qquad ( 4 )$$

$$DS = {\sum }_{i , j , k} {( {S}_{i , j} {D}_{i , j} )}^{{P}_{k} ( i , j )} + {C}_{k} ( i , j ) if i \leq {a}_{k} , j \leq {b}_{k} {∀}_{k} \qquad ( 5 )$$

In an example, the building site and desired construction details are inputs. An example of such input is a home with 2 bedroom with roof size of 1500 square feet and yard size of 4000 square feet with home facing north with a regional identifier. Given these details, the proposed method automatically determines the mandate, maximum potential and automatically formulates the desired optimization problem based on regionally available interventions. The above formulation describes the problem at time t. The effect of specific intervention can be deterministic or stochastic over time. Therefore, the shape of the objective function can be deterministic or stochastic. The proposed method allows for the problem to be solved by deterministic solver methods as well as solving the problem using simulation optimization and/or reinforcement learning. The result is provided as recommended quantity of each intervention. An example of recommendation is 90 units of Solar PV, 1 units of Solar Water Heater, 25 units of Natural STP, 55 units of efficient fixtures, 10 units of Dual flush and 50 units of Waste to bio gas will achieve 67% of DharmaScore with 70% in Energy, 35% in Water, 80% in Waste water dimensions.

The sustainability level handling controller (110) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (140) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) stores the sustainability level information. The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the plurality of modules may be implemented through an Artificial intelligence (AI) model. A function associated with the AI model may be performed through the non-volatile memory, the volatile memory, and the processor (140). The processor (140) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

In another embodiment, the method can be implemented by using a machine learning model. The machine learning model can be, for example, but not limited to a linear regression model, a logistic regression model, a classification and regression tree (CART) model, a naïve bayes model, a k-Nearest Neighbors (KNN) model or the like. Although the FIG. 1 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined together to perform same or substantially similar function in the electronic device (100).

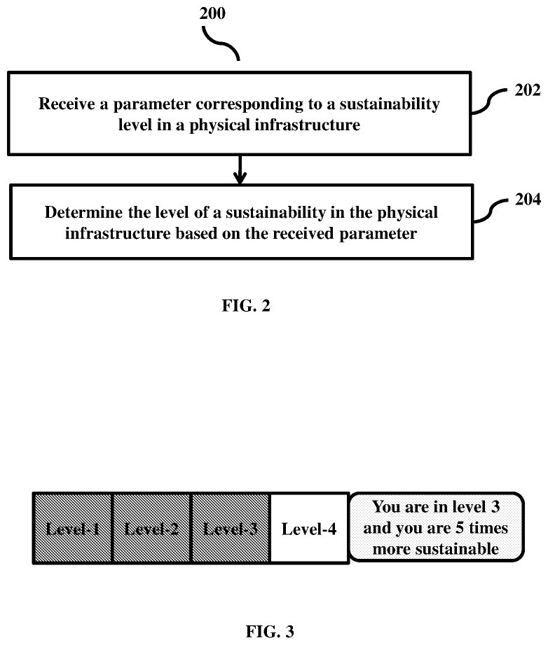

FIG. 2 is a flow chart (200) illustrating a method for handling the level of the sustainability in the physical infrastructure, according to embodiments as disclosed herein. The operations (202 and 204) are handled by the sustainability level handling controller (110).

At 202, the method includes receiving the parameter corresponding to the sustainability level in the physical infrastructure. At 204, the method includes determining the level of the sustainability in the physical infrastructure based on the received parameter.

The various actions in the flow chart (200) may be performed in the order presented, in a different order or simultaneously. Further, in some embodiments, some actions listed in FIG. 2 may be omitted.

The embodiments disclosed herein can be implemented through at least one software program running on at least one hardware device and performing network management functions to control the elements. The elements shown in FIG. 1 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method for handling a sustainability level in a physical infrastructure, comprising:
receiving, by an electronic device (100), at least one parameter corresponding to the sustainability level in the physical infrastructure; and
determining, by the electronic device (100), the level of the sustainability in the physical infrastructure based on the at least one received parameter.

2. The method as claimed in claim 1, wherein determining, by the electronic device (100), the level of the sustainability in the physical infrastructure based on the at least one received parameter comprises:
estimating, by the electronic device (100), a sustainability score based on the at least one received parameter, wherein the sustainability score is determined based on a sustainability score contribution of intervention on dimension and an optimal decision value for intervention that impacts dimension; and
determining, by the electronic device (100), the level of the sustainability in the physical infrastructure based on the estimated sustainability score.

3. The method as claimed in claim 1, comprises:
monitoring, by the electronic device (100), at least one received parameter corresponding to the sustainability level in the physical infrastructure over a period of time;
estimating, by the electronic device (100), a feedback corresponding to the at least one received parameter; and
determining, by the electronic device (100), the level of the sustainability in the physical infrastructure based on the estimated feedback.

4. The method as claimed in claim 1, wherein the at least one parameter comprises goals and status at an instant of usage, an interventions solutions selected by a user of the electronic device (100), an impact achieved based on each solution, local environmental challenges, and a definition of each of individual levels.

5. The method as claimed in claim 4, wherein the effect of the intervention is deterministic or stochastic over time.

6. An electronic device (100) for handling sustainability goal setting for a physical infrastructure, comprising:
a processor (140);
a memory (130); and
a sustainability goal setting controller (110), coupled with the processor (140) and the memory (130), configured to:
receive at least one parameter corresponding to the sustainability level in the physical infrastructure; and
determine the level of the sustainability in the physical infrastructure based on the at least one received parameter.

7. The electronic device (100) as claimed in claim 6, wherein determine the level of the sustainability in the physical infrastructure based on the at least one received parameter comprises:
estimate a sustainability score based on the at least one received parameter, wherein the sustainability score is determined based on a sustainability score contribution of intervention on dimension and an optimal decision value for intervention that impacts dimension; and
determine the level of the sustainability in the physical infrastructure based on the estimated sustainability score.

8. The electronic device (100) as claimed in claim 6, wherein the sustainability goal setting controller (110) is configured to:
monitor at least one received parameter corresponding to the sustainability level in the physical infrastructure over a period of time;
estimate a feedback corresponding to the at least one received parameter; and
determine the level of the sustainability in the physical infrastructure based on the estimated feedback.

9. The electronic device (100) as claimed in claim 6, wherein the at least one parameter comprises goals and status at an instant of usage, an interventions solutions selected by a user of the electronic device (100), an impact achieved based on each solution, local environmental challenges, and a definition of each of individual levels.

10. The electronic device (100) as claimed in claim 9, wherein the effect of the intervention is deterministic or stochastic over time.
